(19) United States
(12) Patent Application Publication
(10) Pub. No.: US 2025/0272526 A1
(43) Pub. Date: Aug. 28, 2025

(54) STORAGE MEDIUM STORING PROGRAM FOR CAUSING COMPUTER TO EXECUTE METHOD CAPABLE OF ADJUSTING SIZE OF DRAWN IMAGE TO SIZE OF OBJECT, INFORMATION PROCESSING APPARATUS, AND IMAGE PRINTING SYSTEM

(71) Applicant: CANON KABUSHIKI KAISHA, Tokyo (JP)

(72) Inventor: TAKAO IKUNO, Kanagawa (JP)

(21) Appl. No.: 19/058,125

(22) Filed: Feb. 20, 2025

(30) Foreign Application Priority Data
Feb. 27, 2024 (JP) 2024-027345

(51) Int. Cl. G06K 15/02; G06K 15/00; G06T 3/40; G06T 11/20; G06T 11/60

(52) U.S. Cl. CPC G06K 15/1859; G06K 15/007; G06K 15/1843; G06T 3/40; G06T 11/20; G06T 11/60; G06T 2200/24

(57) ABSTRACT

A storage medium storing a program for causing a computer to execute a method capable of adjusting a size of a drawn image to a size of an object. A drawn image is generated on a canvas according to a user operation. A photographed image of an object is acquired. The photograph image is displayed of which the size is changed according to a length concerning an object in the photographed image and a size of the canvas, together with the drawn image. The size of the drawn image displayed together with the photographed image of which the size is changed according to a user operation is adjusted. Print data is generated which at least includes data concerning the drawn image of which the size has been adjusted. The generated print data is transmitted to the printing apparatus.

### BACKGROUND OF THE INVENTION

### Cross-Reference To Priority Application

This application claims the benefit of Japanese Patent Application No. 2024-027345 filed Feb. 27, 2024, which is hereby incorporated by reference herein in its entirety.

### FIELD OF THE INVENTION

The present invention relates to a storage medium storing a program for causing a computer to execute a method capable of adjusting a size of a drawn image to a size of an object, an information processing apparatus, and an image printing system.

DESCRIPTION OF THE RELATED ART

Conventionally, as an activity for admiring or cheering a favorite idol of one's own, a movie actor, a character, or the like (hereinafter referred to as “a supporting activity”), a drawn image formed with a view to attaching to an atypical object, such as a handheld fan or a mask, is printed e.g. by a printing apparatus for home use. As a technique related to the printing operation, Japanese Laid-Open Patent Publication (Kokai) No. 2008-033635 discloses a technique of combining image data of a print job received by an image processing apparatus and image data formed by scanning using the image processing apparatus, and printing combined image data.

Incidentally, when printing a drawn image formed with a view to attaching to an object, it is required to perform printing of the drawn image into a size adapted to the size of the object, but if the object is atypical, it is sometimes difficult to print the drawn image in a size adapted to the size of the object. Hereafter, such related art will be specifically described with reference to FIG. 8. FIG. 8 illustrates an example of part of such a supporting activity as mentioned above, from printing of a drawn image on a recording sheet to attaching of the recording sheet having the drawn image printed thereon to a handheld fan. As shown in FIG. 8, first, in a state ST800, a user uses a mobile terminal 800 to form a drawn image by an image generation application. Note that the drawn image refers to an image formed by drawing characters, lines, figures, and/or the like, or by combining images.

Then, when the drawn image is completed, the user gives a print instruction from the image formation application. This inputs the drawn image formed by the image formation application to a printing apparatus, described hereinafter, as a print job. In a state ST801, the printing apparatus, denoted by 801 prints the drawn image on a recording sheet, such as an A4 sheet, according to a received print job. In a state ST802, the user cuts out a drawn image portion of the recording sheet into a shape adapted to the shape of a handheld fan 802 by using scissors or the like, and the cut-out drawn image portion of the recording sheet is pasted to the handheld fan 802. Thus, the handheld fan 802 to which the drawn image of a user's favorite is pasted is completed.

However, according to such a procedure, there often occurs a case where the size of the drawn image formed by the image generation application of the mobile terminal 800 does not meet the size of the handheld fan 802 which is atypical, resulting in an incapability of a finish intended by a user. In such a case, after adjusting the size of the drawn image by using the image formation application of the mobile terminal 800, the user is required to perform reprinting by using the printing apparatus 801. That is, in many cases, the printed drawn image does not meet the size of the object, and in such cases, the user is required to perform size checking by real object positioning of the drawn image printed for testing and the object, and then return to the image formation application to adjust the size of the drawn image, and thereafter perform printing anew. Further, in the case of the supporting activity, by using an expensive recording sheet, support goods are often finished beautifully, so that there is a fear that such a failure of printing as described above forces users to bear excess costs.

### SUMMARY OF THE INVENTION

The present invention provides a storage medium storing a program for causing a computer to execute a method capable of adjusting a size of a drawn image to a size of an object, an information processing apparatus, and an image printing system.

In a first aspect of the invention, there is provided a non-transitory computer-readable storage medium storing a program for causing a computer to execute a method of controlling an information processing apparatus, wherein the method includes generating a drawn image on a canvas according to a user operation, acquiring a photographed image formed by photographing an object, displaying the photographed image of which a size has been changed according to a length concerning an object in the photographed image and a size of the canvas, together with the drawn image, adjusting the size of the drawn image displayed together with the photographed image of which the size has been changed, according to a user operation, generating print data at least including data concerning the drawn image of which the size has been adjusted, and transmitting the generated print data to the printing apparatus.

In a second aspect of the invention, there is provided an information processing apparatus including an image generation unit configured to generate a drawn image on a canvas according to a user operation, an image acquisition unit configured to acquire a photographed image formed by photographing an object, a display unit configured to display the photographed image of which the size has been changed according to the length concerning the object in the photographed image and a size of the canvas, together with the drawn image, an adjustment unit configured to adjust the size of the drawn image being displayed together with the photographed image of which the size has been changed, according to a user operation, a generation unit configured to generate print data including at least data concerning the drawn image of which the size has been adjusted, and a transmission unit configured to transmit the generated print data to a printing apparatus.

According to the present invention, it is possible to adjust the size of a drawn image to the size of an object to which the drawn image is attached.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of a mobile terminal as an information processing apparatus.

FIG. 2 is a block diagram showing a hardware configuration of a printing apparatus and the like.

FIG. 3 is a diagram showing an example of a supporting activity from printing of a drawn image on a recording sheet to attaching of the recording sheet having the drawn image printed thereon to a handheld fan.

FIG. 4 is a flowchart of a process performed by an image generation application in scenes appearing in FIG. 3.

FIG. 5 is a flowchart of a process performed by a camera application in scenes appearing in FIG. 3.

FIG. 6 is a diagram showing states of display on a console section of a mobile terminal, including a state of display illustrating a screen of a photographed image displayed and a state of display illustrating a screen for inputting length information by a manual input.

FIG. 7 is a diagram showing states of display, including a state of display illustrating a screen where a setting of whether printing of a photographed image is performed or not is made.

FIG. 8 is a diagram showing an example of part of a supporting activity from printing of a drawn image on a recording sheet to attaching of the recording sheet having the drawn image printed thereon to a handheld fan.

### DESCRIPTION OF THE EMBODIMENTS

The present invention will now be described in detail below with reference to the accompanying drawings showing embodiments thereof. The configurations of embodiments described hereinafter are given only by way of example, and the scope of the present invention is not limited to the described configurations. Therefore, a combination of all features described in the embodiments is not essential to solution of the present invention. Further, components of the present invention can be replaced by desired components that can exhibit similar functions. Further, desired components can be added. Moreover, combinations of desired two or more components (features) of the present embodiments can be combined.

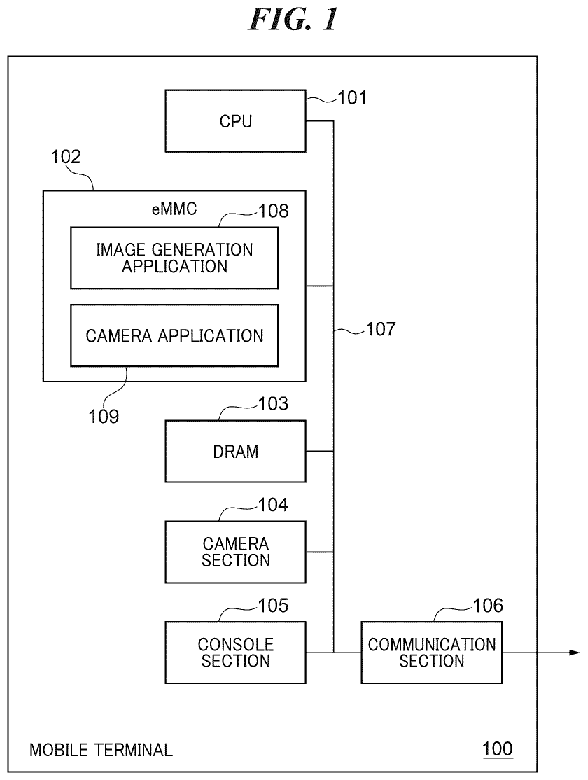

Hereafter, the present embodiments will be described with reference to FIGS. 1 to 8. FIG. 1 is a block diagram showing a hardware configuration of an information processing apparatus. As shown in FIG. 1, as an example of the information processing apparatus, a mobile terminal 100, such as a smartphone, will be described. The mobile terminal 100 includes a central processing unit (CPU) 101, an embedded Multi-Media Card (eMMC) 102, a dynamic random access memory (DRAM) 103, a camera section 104, a console section 105, a communication section 106, and a data bus 107. The CPU 101 is a system controller, which controls overall operation of the mobile terminal 100. The eMMC 102 is implemented by a flash memory, and stores control programs of the CPU 101. Further, the eMMC 102 stores a plurality of applications that operate on the mobile terminal 100. Accordingly, an image generation application 108 and a camera application 109 are stored in the eMMC 102.

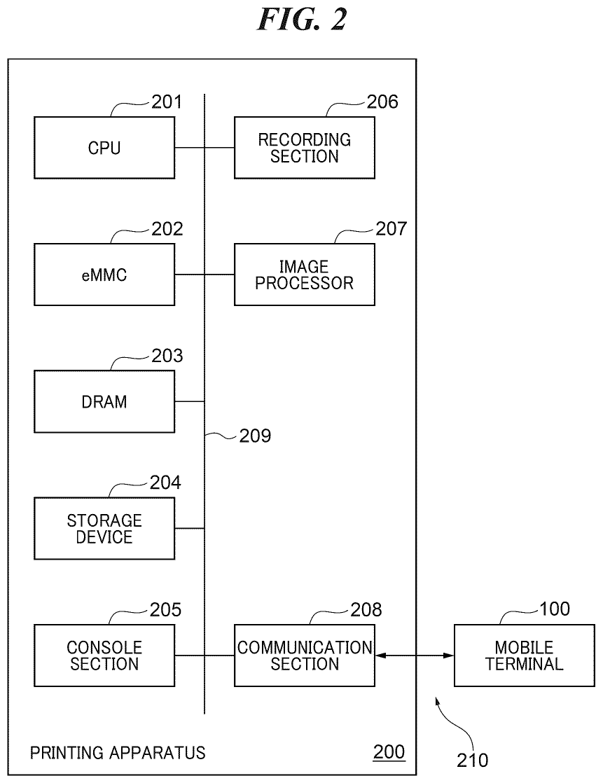

The RAM 103 is a volatile memory that can temporarily store image data processed by the CPU 101 and some of programs. The camera section 104 is a photographing section used by the camera application 109 for image photographing. The console section 105 is an interface section interfacing with a user, which is comprised of a display device, such as a liquid crystal display, that displays information within the mobile terminal 100, and a touch panel. The communication section 106 is an interface section of the mobile terminal 100 with an external communication network. The mobile terminal 100 communicates with a printing apparatus (denoted by 200 in FIG. 2) referred to hereinafter via the communication section 106. The CPU 101, the eMMC 102, the DRAM 103, the camera section 104, the console section 105, and the communication section 106 are connected to each other via the data bus 107. Note that the mobile terminal 100 is not limited to the smartphone, and for example, the mobile terminal 100 can be a tablet terminal, a digital camera, a note-type PC, or the like.

FIG. 2 is a block diagram showing a hardware configuration of the printing apparatus 200 and the like. The printing apparatus 200 includes a CPU 201, an eMMC 202, a DRAM 203, a storage device 204, a console section 205, a recording section 206, an image processor 207, a communication section 208, and a data bus 209. The CPU 201 is a system controller, which controls overall operation of the printing apparatus 200. The eMMC 202 is implemented by a flash memory, and stores control programs of the CPU 201. The DRAM 203 is a volatile memory that can temporarily store processed image data and the like. Further, program control variables and the like are stored in the DRAM 203.

The storage device 204 is for example a hard disk drive (HDD), which is a non-volatile memory that stores image data and the like. Note that data forming a printed matter is stored in the storage device 204. The console section 205 is an interface section with a user, which is comprised of a display device, such as a liquid crystal display, that displays information within the printing apparatus 200, and a touch panel. The recording section 206 is a device that prints print data on a recording sheet. The recording section 206 puts toner to a recording sheet. Further, the recording section 206 applies pressure to the recording sheet on which the toner is put, by using a heated fixing device, not shown, to thereby fix the toner to the recording sheet.

The image processor 207 performs combining of image data to be used for printing, and drawing, and further performs encoding/decoding processing of the binary image data. The communication section 208 is an interface section of the printing apparatus 200 with an external communication network. The printing apparatus 200 communicates with the mobile terminal 100 via the communication section 208. The CPU 201, the eMMC 202, the DRAM 203, the storage device 204, the console section 205, the recording section 206, the image processor 207, and the communication section 208 are connected to each other via the data bus 209. Note that the printing apparatus 200 is connected to the mobile terminal 100 via the communication section 208, thereby constructing an image printing system 210.

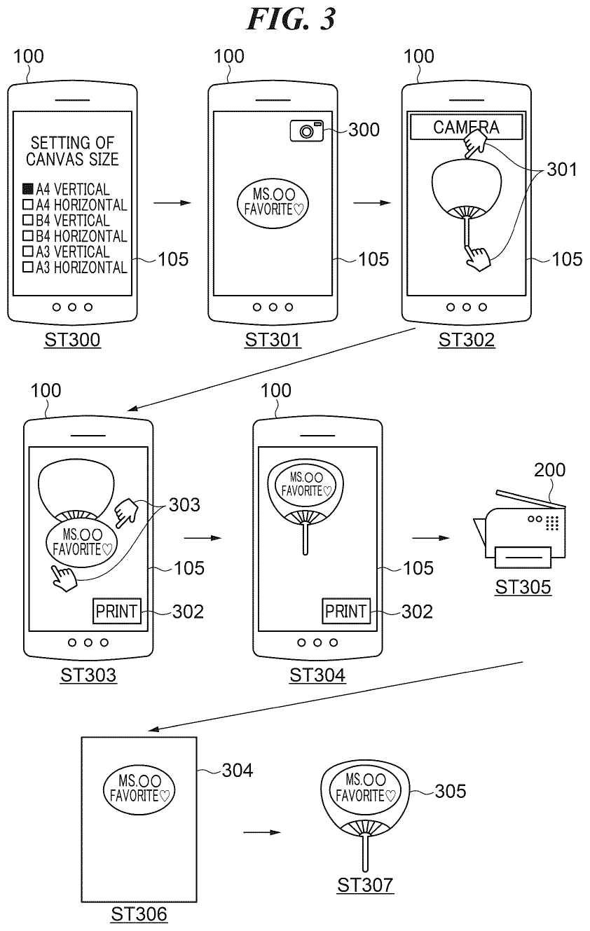

FIG. 3 is a diagram showing an example of a supporting activity from printing of a drawn image on a recording sheet to attaching of the recording sheet having the drawn image printed thereon to a handheld fan, in the present embodiment. First, in a state ST300, a user starts up the image generation application 108 in the mobile terminal 100. Further, in the state ST300, the image generation application 108 displays, on the console section 105, a screen for making a setting of a size of a canvas for drawn image generation. Note that in the present embodiment, it is assumed that a vertical A4 size is selected by a user operation.

In a state ST301, the image generation application 108 receives a user operation with a view to formation of a drawn image on the console section 105 of the mobile terminal 100. With this, the image generation application 108 displays and generates a drawn image on the canvas of the console section 105 of the mobile terminal 100 according to a received user operation. Note that the image generation application 108 forms a drawn image of a user's favorite, by cutting out and combining an image photographed by the mobile terminal 100 and a downloaded image, drawing characters, lines, figures, and the like, and disposing an object. Further, in the state ST301, the image generation application 108 receives an input from a camera button 300 displayed on the console section 105 of the mobile terminal 100. Then, e.g. after completion of the drawn image, when the user taps the camera button 300, the image formation application 108 instructs a change of application movement to the mobile terminal 100. This causes the mobile terminal 100 to start up the camera application 109.

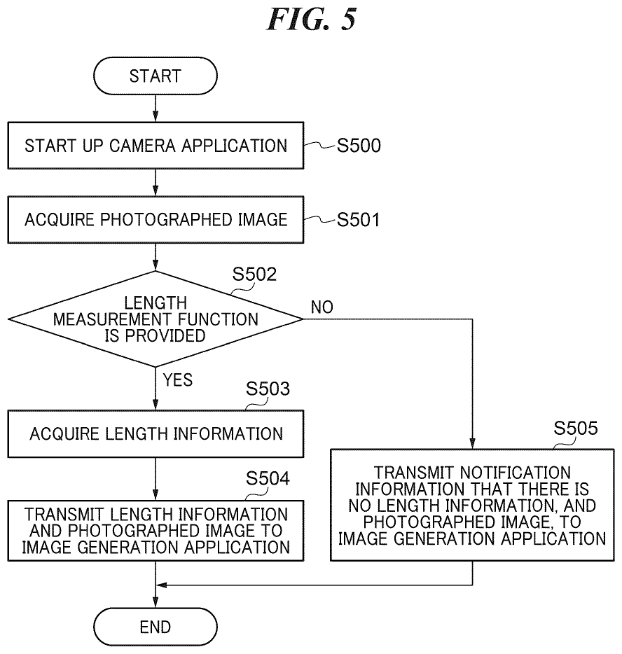

In a state ST302, the camera application 109 receives a user operation to photograph a handheld fan by the camera section 104, thereby acquiring a photographed image of the handheld fan. In doing this, when provided with a length measurement function, the camera application 109 receives two point designations 301 by a user operation to measure a length of the handheld fan. Note that detailed description concerning the length measurement function will be given hereinafter with reference to a flowchart in FIG. 5. Further, in the state ST302, when photographing by the camera section 104 is completed, the camera application 109 notifies the completion of photographing to the mobile terminal 100. This causes the operation of the mobile terminal 100 to return from an operation of the camera application 109 to an operation of the image generation application 108.

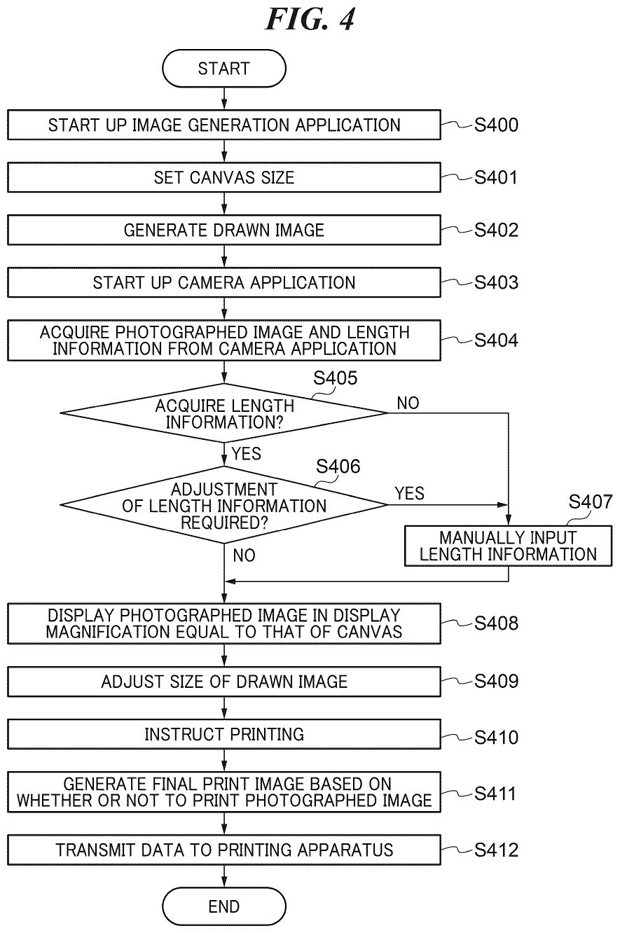

In a state ST303, the image generation application 108 displays a photographed image of the handheld fan and a print button 302 on the console section 105 of the mobile terminal 100. In doing this, the image generation application 108 changes the size of the drawn image on the handheld fan, according to the size of the canvas set in the state ST300 and the length of the handheld fan measured in the state ST302, such that the display magnification of the photographed image of the handheld fan becomes equal to the display magnification of the canvas. Note that a specific description of performing a size-changed display will be given when describing a step S408 in FIG. 4, referred to hereinafter. Further, in the state ST303, the image generation application 108 receives a user operation for adjusting the size of an object included in the generated drawn image.

Specifically, the image generation application 108 receives, on the console section 105 of the mobile terminal 100, a user operation 303 of pinch-in/pinch-out on an object included in the generated drawn image, to thereby adjust the size of the object. This makes it possible to easily adjust the size of an object included in the drawn image generated by the image generation application 108, on the console section 105 of the mobile terminal 100, while referring to the size of a handheld fan included in the photographed image. Further, the user moves the object of the drawn image of which the size is adjusted, by an operation such as dragging on the console section 105 of the mobile terminal 100, whereby the object is superposed on the handheld fan in the photographed image.

In the state ST303 and a state ST304, the image generation application 108 receives an input from the print button 302, on the console section 105 of the mobile terminal 100. After terminating the adjustment/movement, when the print button 302 is tapped by the user, the image generation application 108 gives a print instruction to the printing apparatus 200. In a state ST305, the printing apparatus 200 receives the print instruction, and performs printing in A4 size set on the console section 105 of the mobile terminal 100. In a state ST306, the user receives a recording sheet 304 having a A4 size, which is output from the printing apparatus 200. Note that the recording sheet 304 received by the user is printed with an object of the drawn image generated by the image generation application 108 and further subjected to size adjustment.

In a state ST307, the user performs shaping of an object portion of the drawn image on the recording sheet 304 by cutting out the same using e.g. scissors such that the object portion fits to the shape of the handheld fan, denoted by reference numeral 305. Further, in the state ST307, the user pastes the shaped object portion of the drawn image on the recording sheet 304 to the handheld fan 305. Thus, the handheld fan 305 having an object of the drawn image of user's favorite pasted thereon is completed. As a general sequence, the procedure described above is followed to thereby print an object of a drawn image in a size as intended by the user, which is adapted to the size of the handheld fan 305.

FIG. 4 is a flowchart of a process performed by the image generation application 108 in scenes shown in FIG. 3. Steps in the flowchart shown in FIG. 4 are realized by the CPU 101 (computer) reading a program of the image generation application 108 stored in the eMMC 102 into the DRAM 103 and executing the program. In the flowchart shown in FIG. 4, first, in a step S400, the CPU 101 receives a user operation on the console section 105, thereby starting up the image generation application 108.

In a step S401, the image generation application 108 causes the CPU 101 to display a screen for setting a size of a canvas for drawn image generation, on the console section 105, e.g. as shown in the state ST300. Further, the image generation application 108 causes the CPU 101 to receive a setting of the size of the canvas by a user operation on the console section 105. Thus, the size of the canvas is set.

In a step S402, the image generation application 108 causes the CPU 101 to receive a user operation intended for generation of a drawn image, on the console section 105. Then, the image generation application 108 causes the CPU 101 (image generation unit) to generate a drawn image including an object combined/drawn on the canvas, according to a user operation received on the console section 105. This causes the drawn image to be displayed on the console section 105 e.g. as shown in the state ST301. Further, in the step S402, the image generation application 108 causes the CPU 101 to display the camera button 300 on the console section 105, and receive an input from the camera button 300, e.g. as shown in the state ST301.

In a step S403, the CPU 101 receives, from the image generation application 108, an instruction for switching applications according to the input from the camera button 300 through a tapping operation of the user. With this, the CPU 101 starts up the camera application 109. In a step S404, from the camera application 109, the CPU 101 (image acquisition unit) acquires a photographed image formed by photographing an object (e.g. the handheld fan in the state ST302). In doing this, in a case where the camera application 109 has a length measurement function, the CPU 101 also acquires length information from the camera application 109. Note that detailed description of the length measurement function and length information will be given hereinafter with reference to the flowchart in FIG. 5. Further, in the step S404, from the camera application 109, the CPU 101 receives an instruction for switching applications. With this, the CPU 101 switches the operation of the camera application 109 to that of the image generation application 108.

In a step S405, the image generation application 108 causes the CPU 101 to determine whether or not the length information has been received from the camera application 109. In a case where the image generation application 108 has caused the CPU 101 to determine that the length information has been received from the camera application 109, the process proceeds to a step S406. On the other hand, in a case where the image generation application 108 has caused the CPU 101 to determine that the length information has not been received from the camera application 109, the process proceeds via a state ST602, referred to hereinafter, to a step S407.

In the step S406, the image generation application 108 causes the CPU 101 to determine whether or not the length information acquired from the camera application 109 is required to be adjusted. In doing this, the image generation application 108 causes the CPU 101 to display on the console section 105, for example, a screen provided with a button for prompting a user to select one of two choices, and receive an input from the button to thereby determine whether or not the adjustment is required according to the input. A reason for the necessity of adjustment of the length information acquired from the camera application 109 is that the length information sometimes includes an error exceeding an allowable range. In a case where the image generation application 108 has caused the CPU 101 to determine that the length information acquired from the camera application 109 is required to be adjusted, the process proceeds to the step S407. On the other hand, in a case where the image generation application 108 has caused the CPU 101 to determine that the length information acquired from the camera application 109 is not required to be adjusted, the process proceeds to the step S408.

In the step S407, the image generation application 108 causes the CPU 101 to display, on the console section 105, a photographed image, and further a screen for manually inputting length information to thereby receive an input of the length information. Thus, the length information is acquired. In the step S408, the image generation application 108 causes the CPU 101 (display unit) to display a photographed image acquired in the step S404 together with a drawn image generated in the step S402, e.g. as shown in the state ST303, on the console section 105. In doing this, the image generation application 108 causes the CPU 101 to change the size of the photographed image according to the size of the canvas, which has been set in the step S401, and the length information acquired in the step S404 or the step S407, and display the resulting photographed image on the console section 105.

Further, the image generation application 108 causes the CPU 101 to change the size of the photographed image, such that the display magnification of the object in the photographed image becomes equal to the display magnification of the canvas. Specifically, let it be assumed that a canvas having 1240×1754 pixels is displayed on the console section 105. Further, let it be assumed that in the step S401, the size of the canvas is set to an A4 vertical size. In this case, since the A4 vertical size is 210 mm×297 mm, one pixel on the console section 105 displaying the canvas is 210 mm=1240 pixels, and hence corresponds to a length of 0.17 mm or so. Therefore, in a case whether the length included length information acquired in the step S404 or the step S407 is 170 mm, from 170 nm=0.17 mm, the photographed image of which the size is changed such that a length of 170 mm corresponds to 1000 pixels is displayed on the console section 105.

In a step S409, the image generation application 108 causes the CPU 101 (adjustment unit) to receive an instruction for increasing or reducing the size of the drawn image by a user operation on the consoles section 105, and perform size adjustment of the drawn image. In doing this, on the console section 105, the user performs a pinch-in/pinch-out operation on the drawn image, while referring to the size of an object (specifically, the handheld fan in the state ST303) in the photographed image, whereby the drawn image is adjusted to a desired size. Further, the user moves the drawn image of which the size has been adjusted on the console section 105 by a dragging operation or the like, to thereby cause the drawn image to be interposed on the object (specifically, e.g. the handheld fan in the state ST304) in the photographed image. Thus, the print image is once completed. Further, in the state S409, the image generation application 108 causes the CPU 101 to display the print button 302 on the console section 105, as shown in the state ST303 or the state ST304, to thereby receive an input from the print button 302.

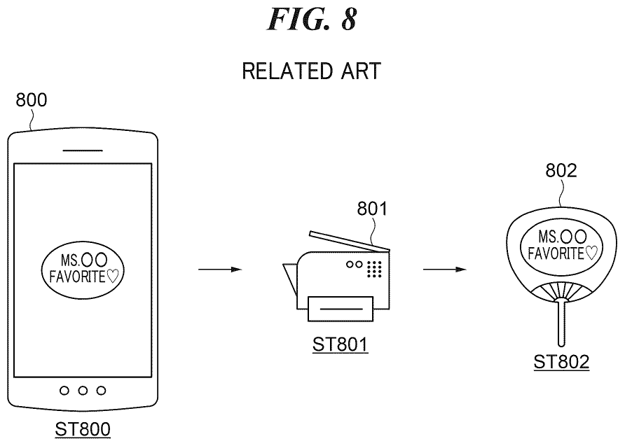

In a step S410, the image generation application 108 causes the CPU 101 to give a print instruction to the printing apparatus 200 according to the input from the print button 302 on which a tapping operation is performed by the user. In a step S411, the image generation application 108 causes the CPU 101 to display a screen on which buttons are provided for prompting the user to select whether or not to print an object in the photographed image, to thereby receive an input of the selected button. Further, in the step S411, the image generation application 108 causes the CPU 101 (generation unit) to generate a final print image, according to a determination result of the received input, and generate print data concerning the final print image. Note that a detailed description concerning the final print image will be given hereinafter with reference to FIG. 8.

In a step S412, the image generation application 108 causes the CPU 101 (transmission unit) to transmit the print data to the printing apparatus 200, followed by terminating the process shown in FIG. 4. Thus, the process of the image generation application 108 in the scenes shown FIG. 3 is performed. Note that in the printing apparatus 200, the CPU 201 causes the print data to be printed on the recording sheet 304 using the recording section 206 (printing unit) e.g. as shown in the state ST306. However, in the case of the example shown in the state ST306, the object (e.g. the handheld fan in the state ST304) in the photographed image is not printed on the recording sheet 304.

FIG. 5 is the flowchart of the process performed by the camera application 109 in scenes appearing in FIG. 3. Steps in the flowchart shown in FIG. 5 are realized by the CPU 101 (computer) reading a program of the camera application 109 stored in the eMMC 102 into the DRAM 103 and executing the program. In the flowchart shown in FIG. 5, first, in a step S500, the CPU 101 receives an instruction from the image generation application 108 in the step S403, whereby the camera application 109 is started up.

In a step S501, the camera application 109 causes the CPU 101 to receive a user operation on the console section 105, and photograph an object by the camera section 104. In doing this, the user operates the console section 105 such that an object (e.g. the handheld fan in the state ST302) to which the drawn image is to be pasted is photographed. Thus, a photographed image is acquired. In a step S502, the CPU 101 determines whether or not the camera application 109 is equipped with a length measurement function. In a case where the CPU 101 determines that the camera application 109 is equipped with the length measurement function, the process proceeds to a step S503. On the other hand, in a case where the CPU 101 determines that the camera application 109 does not have the length measurement function, the process proceeds to a step S505.

In the step S503, the CPU 101 measures a length between the two points in the object in the photographed image by using the length measurement function, to thereby acquire length information in which a value of the measured length is included. Note that the length measurement function is a function of measuring, when the user designates two points, on an object detected by analysis of the photographed image on the console section 105, the length between the designated two points. More specifically, the camera application 109 causes the CPU 101 to receive the two point designations 301 by a user operation, on the console section 105, e.g. as shown in the state ST302. Thus, the user can designate the two points of the length desired to be measured by the length measurement function, in a photographed image of an object to which the drawn image is to be pasted. Further, the CPU 101 measures the length between the designated two points by the length measurement function of the camera application 109. Note that detection of an object in the length measurement function is performed by estimating an object from a photographed image, or by estimating an object from a distance determined by irradiating the object e.g. with laser.

In a step S504 following the step S503, the camera application 109 causes the CPU 101 to transmit the length information and the photographed image to the image generation application 108, followed by terminating the process in FIG. 5. On the other hand, in the step S505, the camera application 109 causes the CPU 101 to transmit notification information that there is no length information and the photographed image to the image generation application 108, followed by terminating the process in FIG. 5. Thus, the process by the camera application 109 in the scenes shown in FIG. 3 is performed.

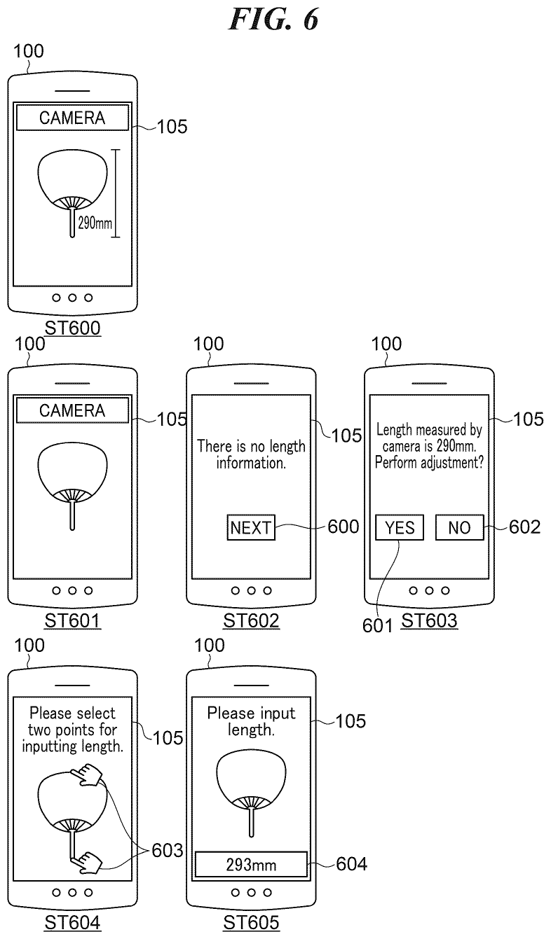

FIG. 6 is a diagram showing states of display on the console section 105 of the mobile terminal 100, including a state of display illustrating a screen of a photographed image displayed and a state of display illustrating a screen for inputting length information by a manual input. In a state ST600, the camera application 109 having a length measurement function displays the photographed image on the console section 105. Further, the camera application 109 displays the length between the two points in a handheld fan which is an object in a photographed image, by the length measurement function. In doing this, the length displayed on the console section 105 is used as a measurement value included in the length information. Note that a screen shown in the state ST600 is a screen which the CPU 101 is caused to display on the console section 105 in the step S501 by the camera application 109 having the length measurement function.

On the other hand, in a state ST601, the camera application 109 not having the length measurement function displays the photographed image on the console section 105. Note that the screen shown in the state ST601 is a screen which the CPU 101 is caused to display on the console section 105 in the step S501 by the camera application 109 not having the length measurement function. In this case, since the camera application 109 does not have the length measurement function, it is impossible to measure a length between two points in the handheld fan in the photographed image and acquire the length information. Therefore, the camera application 109 cannot display information on the length of the handheld fan in the photographed image on the console section 105. Therefore, when the display screen on the console section 105 is returned from a screen by the camera application 109 to a screen by the image generation application 108, the user information is required to be input from the user (steps S404 to S407).

For this reason, in the state ST602, when the operation of the application of the mobile terminal 100 is switched to that of the image generation application 108, the image generation application 108 displays a screen for prompting manual input of length information, on the console section 105. Further, the image generation application 108 receives an input from “NEXT” button 600 displayed on the console section 105. Then, when the “NEXT” button 600 is tapped by the user, the image generation application 108 changes the display screen on the console section 105 to a screen (screen in a state ST604) for prompting the user to manually input length information. Note that the screen shown in the state ST602 is a screen displayed on the console section 105 by the image generation application 108 in the step S405, in a case where the length information cannot be acquired by the CPU 101 in the step S404).

In a state ST603, the image generation application 108 displays, on the console section 105, a screen for prompting the user to select whether or not to adjust the measurement value, which is included in the length information acquired from the camera application 109 having the length measurement function. At this time, a measurement value included in the length information is displayed on the console section 105. Further, the image generation application 108 selectively receives an input from a “YES” button 601 and an input from a “NO” button 602, which are displayed on the console section 105. Then, when the “NO” button 602 is tapped by the user, the image generation application 108 uses a measurement value included in the length information, as it is. Therefore, the user is only required to perform an operation for tapping the “NO” button 602, if the measurement value displayed on the console section 105 is within a range intended by the user.

On the other hand, if the “YES” button 601 is tapped by the user, the image generation application 108 changes the display screen on the console section 105 to a screen (in the state ST604) for prompting the user to manually input length information. Note that the screen shown in the state ST603 is a screen displayed on the console section 105 in the step S406 by the image generation application 108, in a case where the length information could be acquired by the CPU 101 in the step $404.

In the state ST604, the image generation application 108 displays the photographed image on the console section 105. In doing this, the image generation application 108 displays the photographed image on the console section 105, such that the display magnification of the handheld fan in the photographed image is equal to the display magnification of the canvas. However, the image generation application 108 can display the photographed image on the console section 105 with a desired display magnification. For example, the image generation application 108 displays the photographed image on the console section 105 with a number of pixels with which the camera application 109 has performed photographing using the camera section 104. In short, the image generation application 108 displays the photographed image acquired from the camera application 109, with an original size, on the console section 105.

Further, the image generation application 108 receives, on the console section 105, two point designations 603 by user's tapping operation on the handheld fan in the photographed image. Note that in a case where the size of a handheld fan in the photographed image displayed on the console section 105 is not suited to the two point designations 603, the user increases or reduces the size of the display screen on the console section 105, by using smartphone functions and the like. Upon receipt of the two point designations 603, the image generation application 108 changes the display screen on the console section 105 to a screen (in a state ST605) for a user to input an actual measurement value.

In the state ST605, the image generation application 108 displays a screen provided with an input field 604, on the console section 105. Further, the image generation application 108 receives an input to the input field 604 on the display screen on the console section 105. In doing this, the user actually measures a length between the two points on the handheld fan indicated by the two point designations 603, respectively, e.g. by using a graduated rule, and inputs the actual measurement value to the input field 604 by operating the console section 105. Note that screens shown on the states ST604 and 605 are screens which the image generation application 108 causes the CPU 101 to display, on the console section 105 in the step S407. Thus, the image generation application 108 is capable of acquiring length information including a measurement value, even in a case where the camera application 109 does not have the length measurement function.

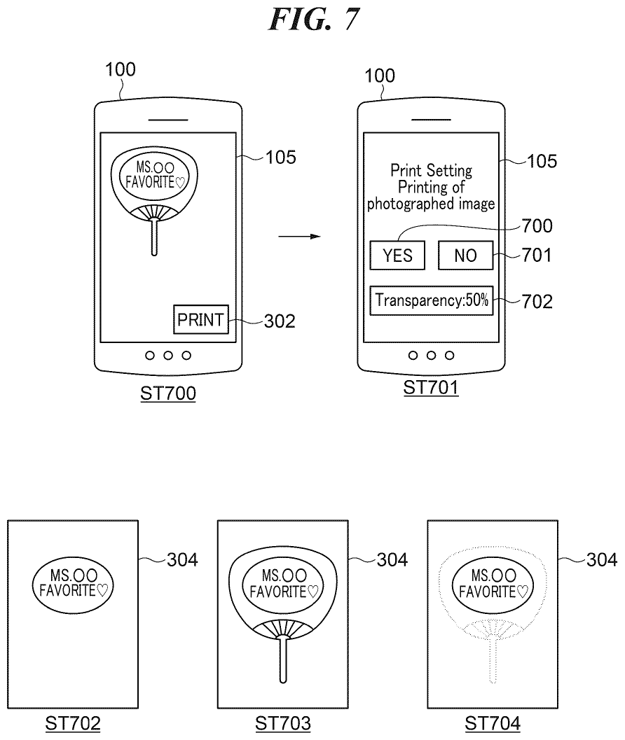

FIG. 7 is a diagram showing states of display, including a state of display illustrating a screen where a setting of whether printing of a photographed image is performed or not is made. A state ST700 is similar to the state ST304. Therefore, when the display screen is in the state ST700, the image generation application 108 receives, on the console section 105 of the mobile terminal 100, a user's operation for size adjustment or movement of a drawn image, whereby the photographed image is once completed. Further, when the user taps the print button 302, the image generation application 108 changes the display screen on the console section 105 to a screen (in a state ST701) for prompting a user to select whether or not to print a handheld fan which is an object in a photographed image. The reason for printing the handheld fan in the photographed image is that although the photographed image is not an image desired by the user to paste to the handheld fan, it can serve as a guideline for cutting out a portion of the drawn image printed on the recording sheet 304 by using scissors. Note that the screen shown in the state ST700 is a screen which the image generation application 108 causes the CPU 101 to display on the console section, in the step S409 or in the step S410.

In the state ST701, the image generation application 108 causes the CPU 101 to display a print setting screen on the console section 105. Note that the print setting screen shown in the state ST701 is a screen which the image generation application 108 causes the CPU 101 to display on the console section 105 in the step S411. Further, the image generation application 108 selectively receives an input from a “YES” button 700 and an input from a “NO” button 701, which are provided on the print setting screen, on the console section 105. When the user taps the “NO” button 701 on the print setting screen being displayed on the console section 105, the image generation application 108 generate image data with which a photographed image is not printed.

On the other hand, when the user taps the “YES” button 700 on the print setting screen being displayed on the console section 105, the image generation application 108 receives an input to the input field 702 provided on the print setting screen. In doing this, the user inputs a degree of transparency for printing a photographed image, to an input field 702, by operating the console section 105. With this, the image generation application 108 generates print data for printing the handheld fan in the photographed image, in concentrations of colors adjusted according to the degree of transparency input to the input field 702.

The reason for adjusting the concentrations of colors is that since the printing of the handheld fan in the photographed image is only used as a guideline, some user desires to lightly print the handheld fan in the photographed image. In this case, the adjustment of concentrations of colors of the drawn image is not executed, but only the concentrations of the colors in the photographed image are reduced, so that the adjustment of the concentrations of the colors hardly affects the printing of the drawn image. Note that in the present embodiment, the adjustment of the concentrations of colors is mentioned, by way of example, but adjustment for making the tastes of colors difficult to be visually recognized, such as changing the print color to yellow, can be performed. Thus, the image generation application 108 causes the CPU 101 of the mobile terminal 100 to perform generation of the print data in the step S411.

A state ST702 shows a recording sheet 304 having only a drawn image printed thereon is shown. To cause the printing apparatus 200 to form the printing sheet 304 shown in the state ST702, the user performs a tapping operation on the “NO” button 701 on the print setting screen on the console section 105 shown in the state ST701. With this, the image generation application 108 causes the CPU 101 of the mobile terminal 100 to transmit print data including only data concerning the drawn image to the printing apparatus 200.

A state ST703 shows the recording sheet 304 having printed thereon the drawn image and the handheld fan of the photographed image having a transparency of 0%. To cause the printing apparatus 200 to form the recording sheet 304 shown in the state ST703, the user performs, after performing an input operation to input the transparency in the printing of the photographed image to 0% to the input field 702, a tapping operation on the “YES” button 700, on the print setting screen on the console section 105 shown in the state ST701. With this, the image generation application 108 causes the CPU 101 of the mobile terminal 100 to transmit print data formed by performing combining such that the drawn image is superimposed on the handheld fan of the photographed image in which the concentrations of colors are increased to 100%, to the printing apparatus 200, in the step S412.

A state ST704 shows the printing sheet 304 having the drawn image and the handheld fan of the photographed image set to a transparency to 50% printed thereon. To cause the printing apparatus 200 to form the recording sheet 304 shown in the state ST704, the user performs, after performing an input operation to input the transparency in the printing of the photographed image to 50% to the input field 702, a tapping operation on the “YES” button 700, on the print setting screen on the operation section 105 shown in the state ST701. With this, the image generation application 108 causes the CPU 101 of the mobile terminal 100 to transmit print data formed by performing combining such that the drawn image is superimposed on the handheld fan in the photographed image having the concentrations of colors lightly adjusted to 50%, to the printing apparatus 200, in the step S412.

As described above, in the mobile terminal 100, the image generation application 108 and the camera application 109 can cause the CPU 101 to operate such that the size of the photographed image is adjusted to the size of the handheld fan 305 to which the drawn image is to be pasted. This enables the user to print a drawn image having an appropriate size without repeatedly changing the used object or moving between the mobile terminal 100 and the printing apparatus 200 in order to perform size adjustment and size confirmation of the drawn image. Further, in doing this, the image generation application 108 necessitates the length of the handheld fan 305 in the photographed image, but if the camera application 109 is equipped with the length measurement function, the length of the handheld fan 305 in the photographed image is automatically measured by the length measurement function. Therefore, it is possible to reduce the burden on the user for performing input operations.

Although the preferred embodiment of the present invention has been described heretofore, the present invention is not limited to the preferred embodiment described above, but various variations and modifications can be made without departing from the spirit and scope of the present invention. For example, the image generation application 108 and the camera application 109 can be realized by one united program, or can be realized by a plurality of programs formed by three or more separate programs. Further, generation of a drawn image (steps S400 to S402) by the image generation application 108 can be executed after acquisition of a photographed image by the camera application 109 (steps S403 to S404). Further, when it is premised that the camera application 109 is equipped with the length measurement function, the steps S405, S502, and S505 can be omitted.

Further, although in the state ST303, by the user operations 303 for pinch-in/pinch-out on a drawn image, the size of the drawn image is increased or reduced, the size of the whole of the display screen on the console section 105 can be increased or reduced. In this case, the image generation application 108 causes the CPU 101 of the mobile terminal 100 to display a switching button on the console section 105 and receive an input from the switching button. When the user performs a tapping operation on the switching button, the image generation application 108 causes the CPU 101 to receive a pinch-in/pinch-out operation by the user for increasing or reducing the whole size of the display screen on the console section 105.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A non-transitory computer-readable storage medium storing a program for causing a computer to execute a method of controlling an information processing apparatus, wherein the method comprises:
generating a drawn image on a canvas according to a user operation;
acquiring a photographed image formed by photographing an object;
displaying the photographed image of which a size has been changed according to a length concerning an object in the photographed image and a size of the canvas, together with the drawn image;
adjusting the size of the drawn image displayed together with the photographed image of which the size has been changed, according to a user operation;
generating print data at least including data concerning the drawn image of which the size has been adjusted; and
transmitting the generated print data to the printing apparatus.

2. The storage medium according to claim 1, wherein the method further comprises changing the size of the photographed image such that a display magnification of the object in the photographed image becomes equal to a display magnification of the canvas.

3. The storage medium according to claim 1, wherein the method further comprises:
determining whether or not the length concerning the object in the photographed image has been acquired;
displaying the photographed image in a case where the length concerning the object in the photographed image has not been acquired;
designating two points on the object in the photographed image being displayed, according to a user operation;
inputting a value according to a user operation; and
acquiring the length concerning the object in the photographed image, by using the input value as a length between the designated two points on the object in the photographed image.

4. The storage medium according to claim 3, wherein the method further comprises:
determining, according to a user operation, whether or not to adjust the length concerning the object in the photographed image, in a case where the length concerning the object in the photographed image has been acquired;
displaying the photographed image, in a case whether the length concerning the object in the photographed image is to be adjusted,
designating, according to a user operation, two points on the object in the photographed image being displayed,
inputting a value according to a user operation; and
adjusting the length concerning the object in the photographed image, by using the input value as the length between the designated two points on the object in the photographed image.

5. The storage medium according to claim 1, wherein the method further comprises:
determining, according to a user operation, whether or not to adjust the length concerning the object in the photographed image;
displaying the photographed image, in a case where the length concerning the object in the photographed image is to be adjusted;
designating two points on the object in the photographed image being displayed, according to a user operation;
inputting a value, according to a user operation, to the information processing apparatus; and
adjusting the length concerning the object in the photographed image by using the input value as the length between the designated two points on the object in the photographed image.

6. The storage medium according to claim 4, wherein the method further comprises acquiring the length concerning the object in the photographed image by measurement using the photographed image.

7. The storage medium according to claim 6, wherein the method further comprises:
displaying the photographed image;
designating two points on the object in the photographed image being displayed, according to a user operation; and
acquiring a length between the designated two points on the object in the photographed image, as the length concerning the object in the photographed image, which has been measured using the photographed image.

8. The storage medium according to claim 1, wherein the method further comprises setting a size of the canvas according to a user operation.

9. The storage medium according to claim 1, wherein the method further comprises:
determining whether or not to print the object in the photographed image, according to a user operation; and
generating the print data including data concerning an image formed by superposing the photographed image of which the size has been adjusted on the object in the photographed image, in a case where the object in the photographed image is to be printed.

10. The storage medium according to claim 1, wherein the method further comprises adjusting concentrations or tastes of colors of the object in the photographed image, in a case where the object in the photographed image is to be printed.

11. The storage medium according to claim 1, wherein the information processing apparatus is a mobile terminal.

12. The storage medium according to claim 1, wherein the user operation for adjusting the size of the drawn image is a pinch-in and a pinch-out.

13. An information processing apparatus comprising:
an image generation unit configured to generate a drawn image on a canvas according to a user operation;
an image acquisition unit configured to acquire a photographed image formed by photographing an object;
a display unit configured to display the photographed image of which the size has been changed according to the length concerning the object in the photographed image and a size of the canvas, together with the drawn image;
an adjustment unit configured to adjust the size of the drawn image being displayed together with the photographed image of which the size has been changed, according to a user operation;
a generation unit configured to generate print data including at least data concerning the drawn image of which the size has been adjusted; and
a transmission unit configured to transmit the generated print data to a printing apparatus.

14. An image printing system including an information processing apparatus and a printing apparatus, wherein the information processing apparatus comprises:
an image generation unit configured to generate a drawn image on a canvas according to a user operation;
an image acquisition unit configured to acquire a photographed image formed by photographing an object;
a display unit configured to display the photographed image of which the size has been changed according to a length concerning the object in the photographed image and a size of the canvas, together with the drawn image;
an adjustment unit configured to adjust, according to a user operation, a size of the drawn image being displayed together with the photographed image of which the size has been changed;
a generation unit configured to generate print data including at least data concerning the drawn image of which the size has been adjusted; and
a transmission unit configured to transmit the generated print data to the printing apparatus,
wherein the printing apparatus comprises a printing unit configured to sprint the print data on a recording sheet.
